(19) United States
(12) Patent Application Publication
(10) Pub. No.: US 2014/0204229 A1
(43) Pub. Date: Jul. 24, 2014

(54) Photo Shooting Control Method and Control Device

(71) Applicant: Muku Labs Limited, Hong Kong (HK)

(72) Inventor: Ho Fai LEUNG, Hong Kong (HK)

(73) Assignee: Muku Labs Limited, Hong Kong (HK)

(21) Appl. No.: 14/158,858

(22) Filed: Jan. 19, 2014

(30) Foreign Application Priority Data
Jan. 21, 2013 (CN) 201310022052.4

(51) Int. Cl. H04N 5/232; H04M 1/02; H04B 7/26

(52) U.S. Cl. CPC H04N 5/23203; H04B 7/26; H04M 1/0264
USPC 348/211.2

(57) ABSTRACT

The present application is directed to a photo shooting control method and control device, the method includes: pairing with a mobile device, and building up a connection with the mobile device upon successful pairing, obtaining key pressing information, and generating a first control signal and a second control signal for transmitting to the mobile device according to the key pressing information. The first control signal or the second control signal controls the shutter release in the camera application of the mobile device for photo shooting. Either signal can be configured though USB or NFC connection by an external device so that the usage of the photo shooting control device can be extended to other applications including PowerPoint, Siri and smart home appliances.

### CROSS REFERENCE TO RELATED PATENT APPLICATIONS

The present application claims benefit of Chinese patent application No. 201310022052.4, the entire contents of which is incorporated by reference.

### FIELD OF THE TECHNOLOGY

The present application is related to a photo shooting control method and control device.

### BACKGROUND

Many users enjoy using mobile phone to take self portrait of themselves, which is now called selfie. However, taking selfies require the user to hold the mobile phone at arm-length, which is not convenient and their faces will usually block most of the background. The present technology applies a remote control for shutter release of mobile phone, but the use of remote control for controlling the shutter release contains the following deficiencies:

The first approach requires a random numeric key to be entered during pairing between the remote control and the mobile phone. It is not only inconvenient to the user; a numerical keypad must be presented on the remote control. Since the remote control size is considerably large, it is not convenient to be carried most of the time.

The second approach requires the users to install a third party camera application on the mobile phone. It is not inconvenient to the users and also the third party camera application usually lacks a number of features present in the native camera app, including zoom, filter and high dynamic range imaging (HDR).

Finally, the present remote control is only compatible with a single kind of mobile operating system. For example, those compatible with iOS are not compatible with ANDROID operating system.

The present remote control is also not configurable because all signal are preset. End user is not able to introduce more functionality including connection to Google Glass, controlling PowerPoint or smart home appliances.

### SUMMARY

In order to solve the aforementioned deficiencies, the present application provides a photo shooting control method and control device, for enhancing ease of outdoor carriage and convenience in usage for the user.

The photo shooting control method includes: pairing with a mobile device, and building up a connection with the mobile device upon successful pairing; obtaining key pressing information, and generating a first control signal and a second control signal according to the key pressing information for transmitting to the mobile device.

The first control signal or the second control signal controls the shutter release in the camera application of the mobile device for photo shooting.

The present application also provides a photo shooting control device includes a remote control. The remote control includes: a key; a pairing module which pairs with the mobile device and builds up a connection with the mobile device upon successful pairing; a signal generating module which obtains key pressing information and generates a first control signal and a second control signal for transmitting to the mobile device according to the key pressing information. The first control signal or the second control signal controls the shutter release in the camera application of the mobile device for photo shooting.

In one embodiment, the number of the pairing module is more than one, each of the pairing module is connected with signal generating module and configured for pairing with each of different mobile devices and building up a connection with each of the different mobile devices upon successful pairing.

In another embodiment, the photo shooting control device further includes a USB connector configured to connect an external USB connector; a charging module connected with the USB connector; and a rechargeable battery connected with the charging module, the pairing module and the signal generating module. The charging module uses an external power which is connected by the USB connector and USB connector to charge the rechargeable battery, the rechargeable battery provides power to the pairing module and the signal generating module.

Optionally, the photo shooting control device further includes a memory which is connected with the USB connector so that the device can also be used as an USB memory drive.

Optionally, the photo shooting control device further includes a Near Field Communication antenna which is coupled to an external Near Field Communication antenna of a Near Field Communication point of sale device; and a Near Field Communication chip connected with the Near Field Communication antenna.

Optionally, the photo shooting control device is integrated with an external battery that works as an external power bank for mobile phone.

Optionally, the signal generating module can be configured externally through the connection of either USB connector or Near Field Communication antenna, sending out customized signals depending on the devices it would like to control. Then the remote can perform much more customized function including Google Glass shutter release, Siri (IOS) remote control, Powerpoint or Keynote control, or remote control for smart home appliances.

In the photo shooting control method and control device of the present application, two control signals are generated simultaneously when the remote control key is pressed. In actual application, these two kinds of control signals can correspond to the two kinds of operating systems respectively, allowing the present application to be compatible with camera applications of different operating systems. The use of original assembled camera application of the mobile device is convenient. Further, the input of password is unnecessary when pairing with the mobile device. Hence, a numerical keypad is not required, which effectively reduces the size of the remote control and enhances outdoor carriage for the user.

### BRIEF DESCRIPTION OF THE DRAWINGS

FIG. 1 is a flow chart of a photo shooting control method according to a first embodiment of the present application.

FIG. 2 is a flow chart of the photo shooting control method according to a second embodiment of the present application.

FIG. 3 is an illustrative view of the appearance of a photo shooting control device in the present application.

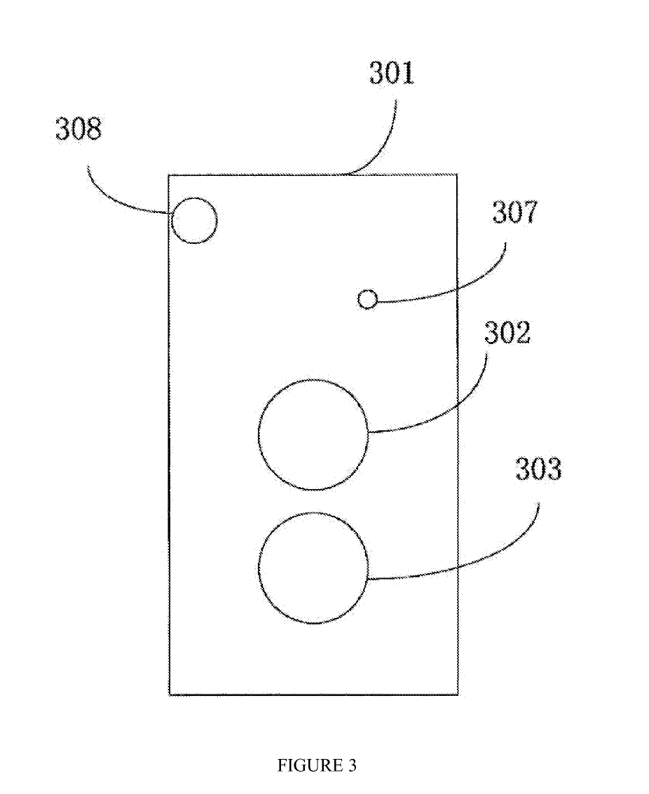

FIG. 4 is a structural illustrative view of the photo shooting control device according to a first embodiment of the present application.

FIG. 5 is a structural illustrative view of the photo shooting control device according to a second embodiment of the present application.

FIG. 6 is a structural illustrative view of the photo shooting control device according to a third embodiment of the present application.

FIG. 7 illustrates a flow chart of the signal configuration method through external devices using USB or NFC connection.

### DETAILED DESCRIPTION

Below is a description of the embodiment of the present application with reference to the drawings. The element and feature described in the drawing or embodiment of the present application can combine with the element and feature illustrated in one or more other drawings or embodiments. It should be emphasized that in order to have a more lucid understanding on those purpose, the drawings and description omit illustration on the components and explanation on the process that are not related to the present application and known by the skilled in the art.

Photo-shooting control method embodiment one:

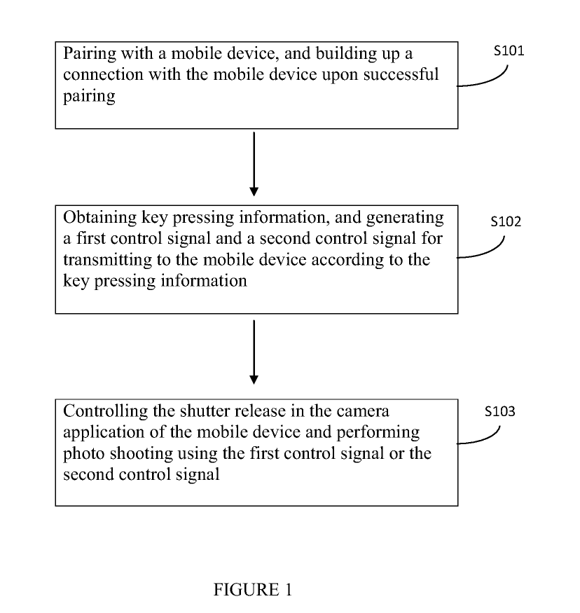

As FIG. 1 illustrates, the present embodiment provides a photo shooting control method, including the following steps:

Step S101: pairing with a mobile device, and building up a connection with the mobile device upon successful pairing.

Step S102: obtaining key pressing information, and generating a first control signal and a second control signal for transmitting to the mobile device according to the key pressing information.

Step S103: controlling the shutter release in the camera application of the mobile device and performing photo shooting using the first control signal or the second control signal.

Preceding Step S101, the method also includes:

Step S100: searching a mobile device.

Specifically, the remote control itself searches the mobile device. After the mobile device has been found, it pairs with the mobile device.

The pairing with the mobile device abides the Bluetooth simple pairing agreement (secure simple pairing). Specifically, the Just Works (both ends password free simple pairing agreement) method is applied for pairing. The input of password is not necessary for Just Works method when pairing. Just works usually work on Bluetooth headset profile but do not work on Bluetooth HID profile because keyboard is a common implementation of HID and password can be transmitted over the Bluetooth connection and the security level from pairing should be higher. However, Bluetooth headset profile draws more energy and also it does not support the second control signal (enter key) so this implementation need to apply Just Works on HID so that the remote shutter release has the best battery life while supporting both iOS and Android camera application. Passcode transmission was suppressed from the remote shutter release during the pairing process of HID and there is a 1-2 minute time allowance from the mobile device before the connection break because of the security bleach. However, this 1-2 minute time frame is already enough for triggering first and or second control signal from the remote shutter release to the mobile device so basically the function is fulfilled without transmitting the passcode. Therefore, it is unnecessary to set up a numerical keypad on the remote control, which effectively reduces the size of the remote control.

A communication connection is built up upon successful pairing with the mobile device and the remote control.

At this moment, if the user presses the key on the remote control, then key pressing information is obtained, and a first control signal and a second control signal are generated according to the key pressing information.

Optionally, the first control signal and the second control signal are generated simultaneously. The first control signal and the second control signal are simultaneously sent to the mobile device to control the shutter release in the camera application of the mobile device.

Specifically, the first control signal is compatible with the camera application of the iOS operating system. That is, the first control signal abides the communication agreement of the iOS operating system. The second control signal is compatible with the camera application of the ANDROID operating system. That is, the second control signal abides the communication agreement of the ANDROID operating system.

If the operating system of the mobile device is the iOS system, then the first control signal controls the shutter release to perform photo shooting. The second control signal is neglected. If the operating system of the mobile device is the ANDROID system, then the second control signal controls the shutter release for photo shooting.

Optionally, the first control signal is generated with a time lag. That is, the first control signal is generated at a definite time later than the generation of the second control signal. The belated time is pre-determined, so as to prevent the first control signal on the amendable version of certain ANDROID system being treated as a control signal of other functions of the camera and affect the operation of the shutter release.

Therefore, the photo shooting control device of the present application is compatible with both the native camera applications of the iOS operating system and the ANDROID operating system.

If the mobile device has not started the camera application, then the first control signal and the second control signal are treated as the volume amplifying (VOL UP) control signal and the confirmation (ENTER) control signal, respectively, for controlling the volume and input confirmation of the mobile device.

The photo shooting control method of the present embodiment simultaneously generates two signals corresponding to iOS operating system and ANDROID operating system, which are compatible with the native camera application of the iOS operating system and ANDROID operating system at the time of key pressing of the remote control. Further, the original assembled camera application of the mobile device is used, which is convenient. The input of password is not necessary when pairing with the mobile device. Therefore, a numerical keypad is not required, which can effectively reduce the size of the remote control and enhance outdoor carriage by the user.

Photo-shooting control method embodiment two:

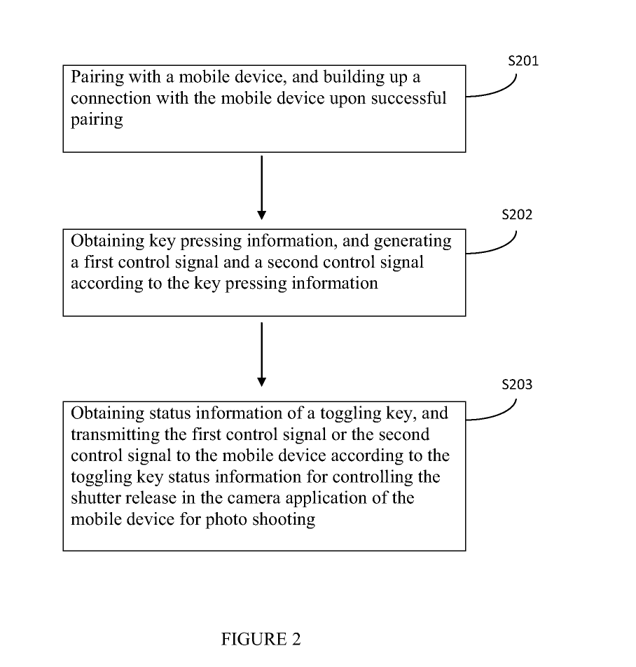

As FIG. 2 illustrates, the present application provides a photo shooting control method, including:

Step S201: pairing with a mobile device, and building up a connection with the mobile device upon successful pairing.

Step S202: obtaining key pressing information, and generating a first control signal and a second control signal according to the key pressing information.

Step S203: obtaining status information of a toggling key, and transmitting the first control signal or the second control signal to the mobile device according to the toggling key status information for controlling the shutter release in the camera application of the mobile device for photo shooting.

Wherein Step S201 and Step S202 are the same as the photo shooting control method of embodiment one, and hence will not be reiterated.

The photo shooting control method in the present embodiment also includes: obtaining status information of a toggling key and transmitting the first control signal or second control signal to the mobile device for controlling the shutter release in the camera application of the mobile device for photo shooting according to the status information of the toggling key.

Specifically, the toggling key is controlled by the user. The toggling key can be set as up/down or left/right type. The present embodiment describes the left/right positions as an example.

If the operating system of the mobile device is iOS system, then the user can toggle the toggling key to the left. If the operating system of the mobile device is ANDROID system, then the user can toggle the toggling key to the right. This is merely an example and does not serve to limit the present application.

The first control signal is compatible with the camera application of the iOS operating system. That is, the first control signal abides the communication agreement of the iOS operating system. The second control signal is compatible with the camera application of the ANDROID operating system. That is, the second control signal abides the communication agreement of the ANDROID operating system.

While generating a first control signal and a second control signal according to the key pressing information, the status information of the toggling key can be obtained at the same time. If at this moment the toggling key is toggled to the left, then the first control signal is transmitted to the mobile device and the second control signal is refrained from transmitting. If at this moment, the toggling key is toggled to the right, then the second control signal is transmitted to the mobile device and the first control signal is refrained from transmitting. The first control signal controls the shutter release in the camera application of the iOS operating system and performs photo shooting. The second control signal controls the shutter release in the camera application of the ANDROID operating system and performs photo shooting.

The types of the toggling key is not limited to up/down or left/right. The application of other type of the key to perform exchange of the first control signal and the second control signal shall all fall within the protection scope of the present application.

The present embodiment provides a photo shooting control method. The user can set the control signal directing against the operating system of the mobile device and at the same time be compatible with camera applications with both iOS operating system and ANDROID operating system.

Photo shooting control device embodiment:

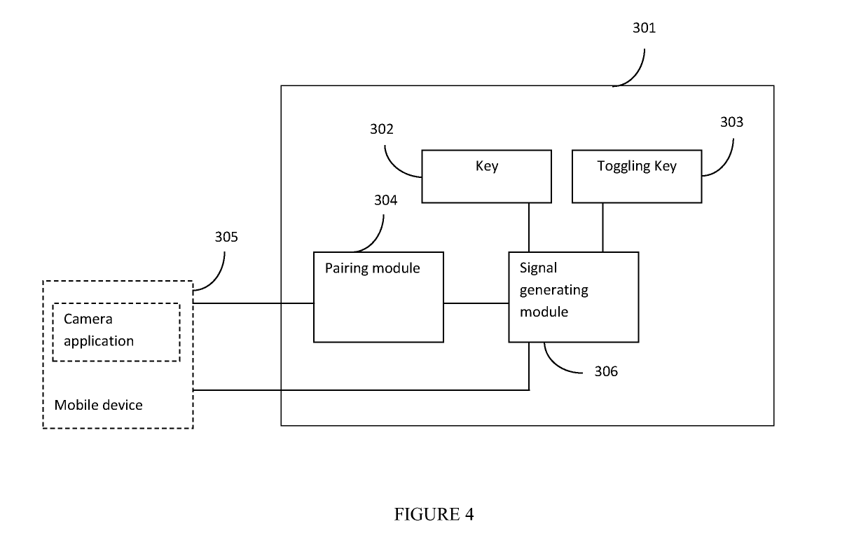

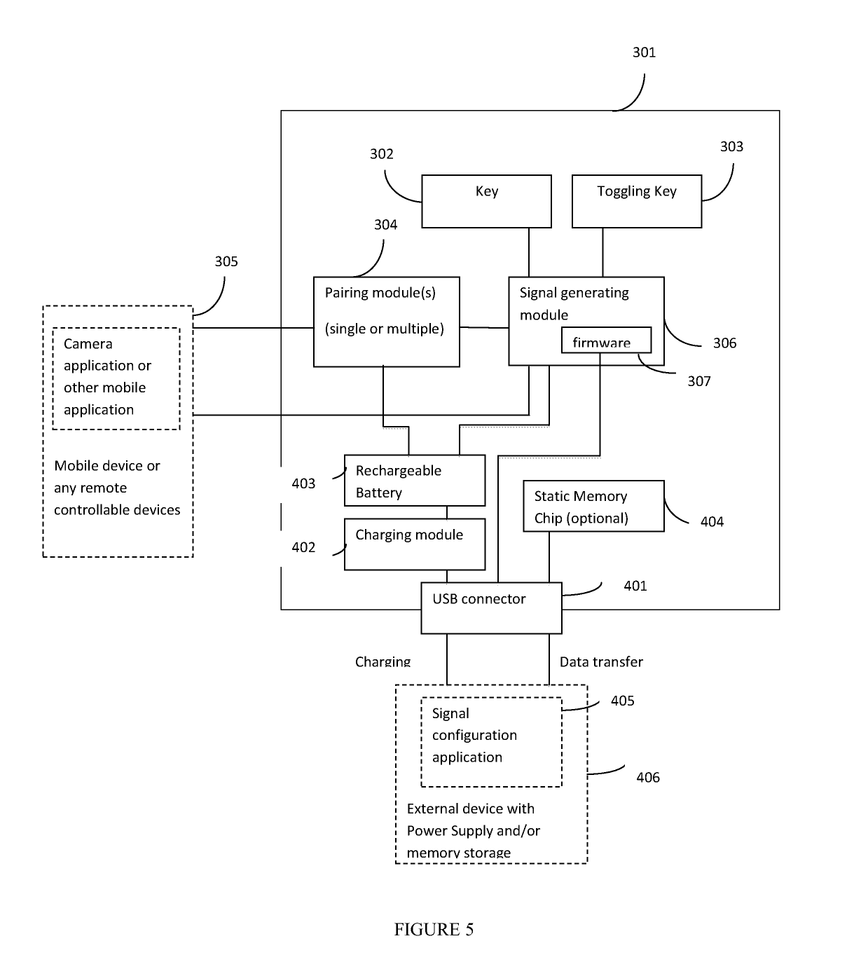

FIG. 4 and FIG. 5 illustrate a photo shooting control device, including a remote control 301. The remote control 301 includes a key 302, a pairing module 304 and a signal generating module 306.

The pairing module 304 is used for pairing with the mobile device 305 and building up a connection with the mobile device 305 upon successful pairing.

The signal generating module 306 is used for obtaining the key pressing information and generating a first control signal and a second control signal according to the key pressing information for transmitting to the mobile device 305.

The remote control 301 in the present embodiment is a blue tooth remote control; the communication is performed with the mobile device 305 based on the blue tooth.

The mobile device in the present embodiment is a device that includes iOS operating system that possesses photo shooting and blue tooth functions, such as iPhone, iPod-touch, iPad etc., and mobile phone, tablet PC etc. with ANDROID operating system that possesses photo shooting and bluetooth function.

Furthermore, the remote control 301 also includes a display module 307 for displaying the working status of the remote control. The display module 307 is preferably an LED lamp. The power source of the remote control 301 is turned on and then the mobile device 305 is searched. When the mobile device 305 has been searched, it would pair with the mobile device 305. At this time, the LED lamp of the display module 307 would show a flash light. The pairing of the pairing module 304 and the mobile device 305 abides simple pairing agreement (simple secure pairing). Specifically, it applies Just Works (both ends password free simple pairing agreement) for performing pairing. The application of such agreement to perform pairing does not require the input of password. Therefore, it is unnecessary to set up a numerical keypad on the remote control 301, which effectively reduces the size of the remote control.

After successful pairing with the mobile device 305, the communication connection is built up. At this time, the LED lamp of the display module 306 would show a lasting light.

At this time, if the user presses down the key 302 on the remote control, the key pressing information is obtained. A first control signal and a second control signal according to the key pressing information are generated. The first control signal and the second control signal are generated simultaneously.

The first control signal and the second control signal are transmitted to the mobile device 305 simultaneously for controlling the shutter release in the camera application of the mobile device for photo shooting.

Specifically, the first control signal is compatible with the camera application of the iOS operating system. That is, the first control signal abides the communication agreement of the iOS operating system. The second control signal is compatible with the camera application of the ANDROID operation system. That is, the second control signal abides the communication agreement of the ANDROID operating system.

If the operating system of the mobile device 305 is an iOS system, then the first control signal controls the shutter release for photo shooting and the second control signal is neglected. If the operating system of the mobile device 305 is an ANDROID system, then the second control signal controls the shutter release for photo shooting.

Therefore, the photo shooting control device in the present embodiment is compatible with the camera application of both the iOS operating system and the ANDROID operating system simultaneously.

A key hole 308 is provided on the remote control 301, for ease of carriage by the user. Furthermore, the remote control 301 is also provided with a toggling key 303, the toggling key 303 can be set up to include up/down or left/right type. The present embodiment applies the left/right type as an example for explanation.

While the first control signal and the second control signal are generated according to the key pressing information, the status information of the toggling key is obtained at the same time. If at this moment, the toggling key is toggled to the left, then the first control signal is transmitted to the mobile device and the second control signal is not transmitted. If at this moment, the toggling key is toggled to the right, then the second control signal is transmitted to the mobile device and the first control signal is not transmitted. The first control signal controls the shutter release of the camera application of the iOS operating system for photo shooting. The second control signal controls the shutter release of the camera application of the ANDROID operating system for photo shooting.

The present application provides a photo shooting control device. While the remote control key is pressed, two signals matching with iOS operating system and matching with ANDROID operating system are generated simultaneously, which are compatible with the programs of photo shooting of the iOS operating system and ANDROID operating system. In addition, the use of original assembled camera application of the mobile device is convenient. The pairing with the mobile device does not require the input of password. Hence, the numerical keypad is not necessary, which effectively reduces the size of the remote control and enhances outdoor carriage by the user.

Referring to FIG. 5, according to the second embodiment of the patent application, the photo shooting control device further includes a USB connector 401, a charging module 402, a rechargeable battery 403. The USB connector 401 is configured to connect an external device with Power Supply and/or memory storage 406. The charging module 402 is connected between the USB connector 401 and the rechargeable battery 403. The rechargeable battery 403 is connected with the pairing module 304 and the signal generating module 306. The charging module 402 receives power from an external device with power supplier which is connected by USB connector 401, and charges the rechargeable battery 403. The rechargeable battery 403 provides power to the pairing module 304 and the signal generating module 306. The external device with power supplier can be used to charge the photo shooting control device. Optionally, a signal configuration application 405 on the external device 406 can configure the firmware 307 of the signal generating module 306 through USB connector 401. In this way the signal generating module 306 can send out customized signals depending on the devices it would like to control. The remote can perform much more customized function including Google Glass shutter release, Siri (IOS) remote control, Powerpoint or Keynote control, or remote control for smart home appliances.

For instance, the photo shooting control device by default generates the first control signal “volume up” or second control signal “enter” to control IOS or Android camera application. However, the photo shooting of Google Glass is controlled by the key “KEYCODE_CAMERA”. Therefore, the phone shooting control device cannot control Google Glass.

By plugging the photo shooting control device to a personal computer through USB connection, user can open a signal configuration application on the personal computer to modify the firmware of the signal generating device so that the signal generate will be “KEYCODE_CAMERA”. In this way, by pairing up the photo shooting control device with Google Glass using bluetooth, user can remote control the photo shooting of Google Glass.

Take another example, the PowerPoint presentation can be controlled by “Delete” and “Enter” key for moving the slides backward and forward. By changing the first signal in signal generating module to “Delete” using USB connection, the photo shooting control device can act as a PowerPoint remote control.

The photo shooting control device further includes a memory 404 which is connected with the USB connector 401. The memory 404 can be a static memory chip. The data can be transferred from an external device with memory storage to the memory 404 through USB connector 401.

The photo shooting control device can act as a USB thumb drive. When the user plugs the photo shooting control device into the computer as a USB thumb drive, the photo shooting control device is charged automatically. The user doesn't even need to remember about charging or replacing battery on the photo shooting control device. No external charging cable is needed.

Referring to FIG. 5, according to the third embodiment of the patent application, the photo shooting control device further includes a Near Field Communication (NFC) antenna 501 and a Near Field Communication (NFC) chip 502. The NFC antenna 501 can be connected to an external NFC terminal 503. The NFC chip 502 is connected with the NFC antenna 501. The frequency range of NFC does not interfere with bluetooth frequency range of the pairing module. The photo shooting control device of this embodiment can provide the payment function. The photo shooting control device can work as a NFC payment card or security control card. Optionally, a signal configuration application 504 on the NFC terminal 503 can configure the firmware 307 of the signal generating module 306 through NFC antenna 501 and NFC chip 502 so that the signal generating module 306 can send out customized signals depending on the devices it would like to control. The remote can perform much more customized function including Google Glass shutter release, Siri (IOS) remote control, Powerpoint or Keynote control, or remote control for smart home appliances.

For instance, the photo shooting control device by default generates the first control signal “volume up” or second control signal “enter” to control IOS or Android camera application. However, the photo shooting of Google Glass is controlled by the key “KEYCODE_CAMERA”. Therefore, the phone shooting control device cannot control Google Glass.

By connecting the photo shooting control device to a mobile phone with NFC connectivity, user can open a signal configuration application on the mobile phone to modify the firmware of the signal generating device so that the signal generate will be “KEYCODE_CAMERA”. In this way, by pairing up the photo shooting control device with Google Glass using bluetooth, user can remote control the photo shooting of Google Glass.

Take another example, the PowerPoint presentation can be controlled by “Delete” and “Enter” key for moving the slides backward and forward. By changing the first signal in signal generating module to “Delete” using NFC connection, the photo shooting control device can act as a PowerPoint remote control.

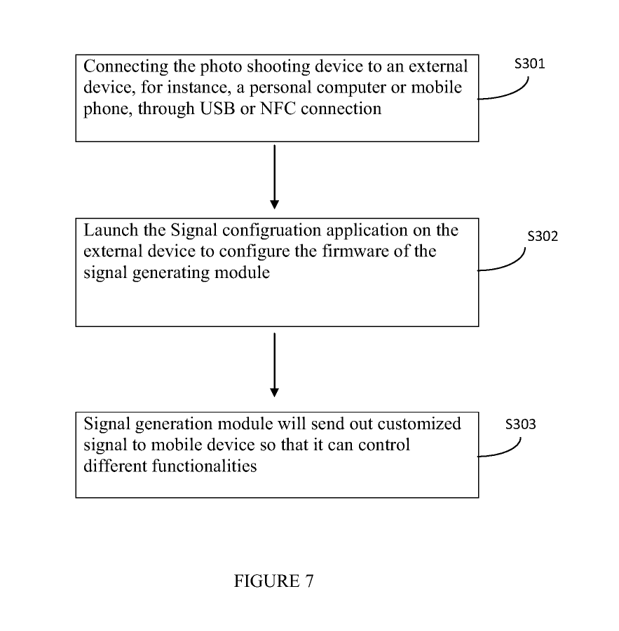

Referring to FIG. 7, the signal configuration method includes the following steps:

Step S301: connecting the photo shooting device to an external device, for instance, a personal computer or mobile phone, through USB or NFC connection.

Step S302: launching the Signal configuration application on the external device to configure the firmware of the signal generating module.

Step S303: signal generation module will send out customized signal to mobile device so that it can control different functionalities.

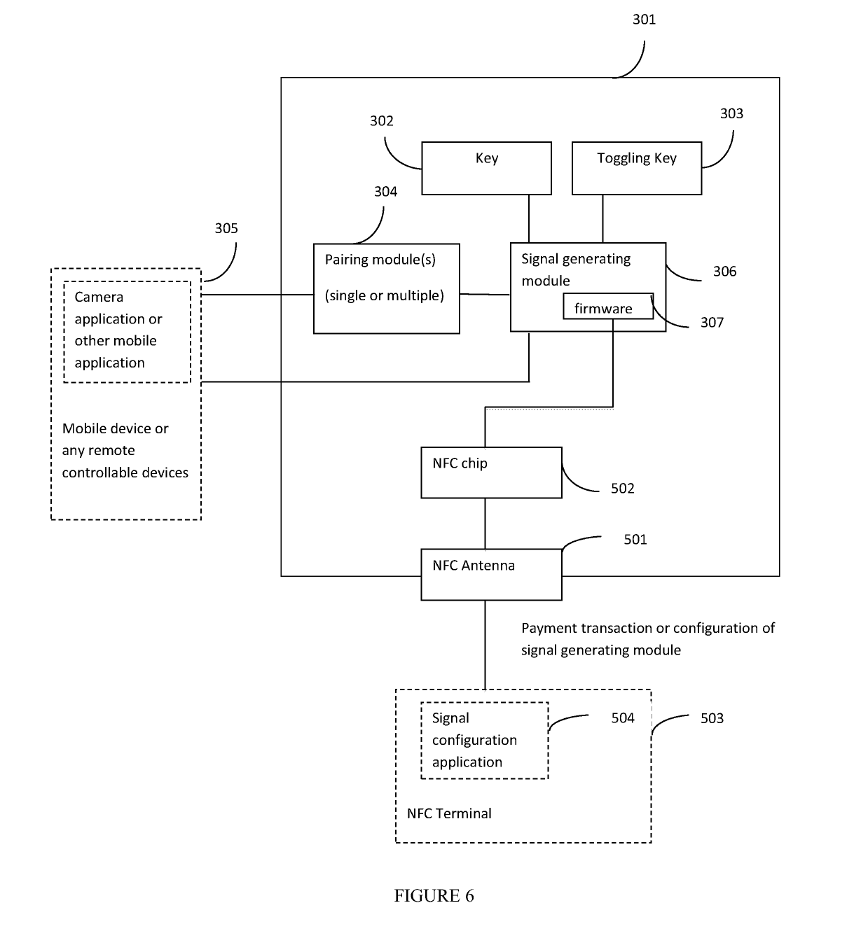

Referring to FIG. 5 and FIG. 6, the number of the pairing module 304 is more than one. Each of the pairing module 304 is connected with signal generating module 306 and configured for pairing with each of different mobile devices 305 and building up a connection with each of the different mobile devices 305 upon successful pairing. The user can use the photo shooting control device to control more than one mobile devices. The photo shooting control device can also be integrated with an external battery.

Despite detailed explanation on the present application and those benefits is provided, it should be understood that amendment, replacement and exchange can be performed under the condition that the spirits and scope of the present application as limited in the attached claims are not exceeded. Furthermore, the scope of the present application does not merely limit to the specific embodiments described on those process, device, technique, method and procedure. It can be easily understood by the skilled in the art of the field based on the content as disclosed in the present application that executing functions that are substantially the same as the corresponding embodiments or obtaining existing process, device, technique, method or procedure that will need to be disclosed with results that are substantially the same as the corresponding embodiment can be possible in view of the present application. Therefore, the claims attached include process, device, technique, method or procedure that falls within whose protection scope.

1. A photo shooting control method, comprising:
S1: pairing with a mobile device, and building up a connection with the mobile device upon successful pairing;
S2: obtaining key pressing information, and generating a first control signal and a second control signal for transmitting to the mobile device according to the key pressing information; and
S3: controlling the shutter release in the camera application of the mobile device for photo shooting using the first control signal or the second control signal.

2. The photo shooting control method according to claim 1, wherein the first control signal is compatible with the camera application of the iOS operating system, the second control signal is compatible with the camera application of the ANDROID operating system.

3. The photo shooting control method according to claim 2, wherein if the operating system of the mobile device is iOS system, then the first control signal controls the shutter release to photo shoot, while the second control signal is neglected; if the operating system of the mobile device is ANDROID system, then the second control signal controls the shutter release and photo shoot.

4. The photo shooting control method according to claim 1, wherein S1 further comprises: applying simple pairing agreement to pair with the mobile device.

5. The photo shooting control method according to claim 4, wherein S1 further comprises: applying both ends password free simple pairing agreement.

6. The photo shooting control method according to claim 1, wherein S2 further comprising: obtaining status information of a toggling key and transmitting the first control signal or the second control signal to the mobile device according to the status information of the toggling key for controlling the shutter release in the camera application of the mobile device for photo shooting.

7. The photo shooting control method according to claim 1, wherein the first control signal and the second control signal are generated simultaneously.

8. The photo shooting control method according to claim 1, wherein the first control signal is generated belatedly.

9. A photo shooting control device, comprising a remote control, the remote control comprises:
a key;
at least one pairing module which pairs with the mobile device and builds up a connection with the mobile device upon successful pairing;
a signal generating module which obtains key pressing information and generates a first control signal and a second control signal for transmitting to the mobile device according to the key pressing information;
wherein the first control signal or the second control signal controls the shutter release in the camera application of the mobile device for photo shooting.

10. The photo shooting control device according to claim 9, wherein the pairing module applies the agreement of simple pairing with the mobile device for pairing.

11. The photo shooting control device according to claim 9, wherein the remote control comprises a display module for displaying the working status of the remote control.

12. The photo shooting control device according to claim 9, wherein the remote control further comprises a toggling key, the signal generating module also transmits the first control signal or the second control signal according to status information of the toggling key to the mobile device for controlling the shutter release in the camera application of the mobile device for photo shooting.

13. The photo shooting control device according to claim 9, wherein the remote control comprises a key hole for hanging purpose.

14. The photo shooting control device according to claim 10, wherein the number of the pairing module is more than one, each of the pairing module is connected with signal generating module and configured for pairing with each of different mobile devices and building up a connection with each of the different mobile devices upon successful pairing.

15. The photo shooting control device according to claim 10, further comprising:
a USB connector configured to connect an external USB connector;
a charging module connected with the USB connector; and
a rechargeable battery connected with the charging module, the pairing module and the signal generating module;
wherein the charging module uses an external power which is connected by the USB connector and USB connector to charge the rechargeable battery, the rechargeable battery provides power to the pairing module and the signal generating module.

16. The photo shooting control device according to claim 15, further comprising a memory which is connected with the USB connector.

17. The photo shooting control device according to claim 15, wherein the signal generating module is configured by an external signal configuration application through the USB connector and sends out a customized signal depending on a device needed to be controlled.

18. The photo shooting control device according to claim 10, further comprising:
a Near Field Communication antenna which is coupled to an external Near Field Communication antenna of a Near Field Communication terminal; and
a Near Field Communication chip connected with the Near Field Communication antenna.

19. The photo shooting control device according to claim 18, the signal generating module is configured by an external signal configuration application through the Near Field Communication antenna and Near Field Communication chip and sends out a customized signal depending on a device needed to be controlled.

20. The photo shooting control device according to claim 10, wherein the photo shooting control device is integrated with an external battery.
